(19) United States
(12) Patent Application Publication
(10) Pub. No.: US 2026/0339003 A1
(43) Pub. Date: Oct. 29, 2026

(54) DIFFUSION FILM AND DIFFUSION FILM PREPARATION METHOD

(71) Applicant: Sichuan Longhua Film Co.,Ltd, Mianyang (CN)

(72) Inventors: RUIMIN DIAO, Mianyang (CN); XINYI LAI, Mianyang (CN); JIALIN LI, Mianyang (CN); BANGFENG ZHU, Mianyang (CN); JIARONG FAN, Mianyang (CN); FANGZHI LU, Mianyang (CN)

(21) Appl. No.: 19/113,398

(22) PCT Filed: Sep. 22, 2023
(86) PCT No.: PCT/CN2023/120818

§ 371 Date: Mar. 19, 2025

(30) Foreign Application Priority Data
Nov. 24, 2022 (CN) 202211482331.4

(51) Int. Cl. G02B 5/02; G02F 1/13357

(52) U.S. Cl. CPC G02B 5/02; G02F 1/1336

(57) ABSTRACT

Disclosed are a diffusion film and a diffusion film preparation method. A light exit surface and/or a light entrance surface of the diffusion film has a continuous or discontinuous optical micro-structure, the optical micro-structure presenting a laminated structure. The optical micro-structure includes a platform, the platform has a light exit end surface, and the platform has a continuous light exit circumferential-side surface. An included angle formed by the light exit end surface of the platform and the light exit circumferential-side surface of the platform is a right angle. Contours of the platforms sequentially enlarge/shrink along a direction perpendicular to the light exit surface of the diffusion film and form a stepped structure, and a projection of the platform at an upper level is located within the contour of the platform at a lower level. The diffusion film preparation method is used for preparing the diffusion film.

### FIELD OF THE INVENTION

The present invention relates to the field of optical film technologies, particularly to a diffusion film and a diffusion film preparation method.

### BACKGROUND OF THE INVENTION

With the extensive application of liquid crystal displays, the backlight modules, as an important component of the liquid crystal display panels, play an important role in improving the quality of the displays and promoting the thinning process of the liquid crystal panels. Based on different positions of light sources in the backlight modules, the backlight modules can be divided into direct-lit and edge-lit backlight modules. Unlike an edge-lit light source arranged on a side of a light exit surface, a direct-lit light source is directly distributed below the light exit surface and does not need to pass through a light guide plate. However, due to the specific light emitting area of an LED light source, the LED light intensity is not uniformly distributed at a specific angle of view. It is difficult for the LED light source to form uniform outgoing light on a target surface, that is, it is difficult to form a surface light source. Therefore, light mixing processing is needed to weaken the phenomenon that the LED light source has a dark light region, a dark light band, or a visible LED light emission means.

At present, the conventional direct-lit structure is typically provided with two layers of diffusion films above the LED light source for light mixing. The main function of the light diffusion film is to convert point light sources and line light sources into surface light sources, and it features high light transmittance, high haze, and the like. Existing diffusion films can provide bulk diffusion and surface diffusion based on different action mechanisms. Bulk diffusion refers to light diffusion achieved mainly by adding heterogeneous particles to a transparent substrate and using the scattering of the particles; while surface diffusion requires the formation of an optical micro-structure on the surface of a transparent substrate through processes such as grinding, photolithography, coating, or sandblasting, thus generating a directionally diffusing surface light source via a large number of light propagation paths.

For example, to improve the uniformity of the outgoing light, in Chinese Patent No. CN1641432A, a diffusion film surface with a columnar lens structure was designed on a diffusion film surface; in Patent No. CN101620283B, a triangular pyramid-shaped micro-structure was designed on a diffusion film surface; and in Patent No. CN201228916Y, a conical micro-structure was designed. In all of these patents, different optical micro-structures were designed on the diffusion film surface to achieve light uniformity. However, such structures all require adding a small number of particles to the diffusion film. The synergistic effect of the particles and the micro-structure surface improves the light uniformity performance of the diffusion film, which undoubtedly increases the production cost and puts forward higher requirements for the processing and molding process of the diffusion film. In addition, the common lens structure includes double layers that interlace each other, causing new defects such as light interference.

To further simplify the processing technology of the diffusion film, some workers have designed a diffusion film surface into pyramid and pseudo-pyramid structures. For example, in Chinese Patent No. CN114624799A, a diffusion film surface includes a pseudo-pyramid structure with multiple apex angles, and increasing the dispersion points improves the light uniformity of the diffusion film. This structure can avoid the use of conventional process diffusers to a certain extent. However, it has little effect on improving the light uniformity of the diffusion film.

### SUMMARY OF THE INVENTION

The present invention provides a diffusion film to resolve the above deficiencies in the prior art. A laminated optical micro-structure is formed on the diffusion film, and the light exit amount in the horizontal direction of the laminated micro-structure is controlled to achieve controllable reflection or refraction of a light path, improving the light mixing effect between LED light sources, thereby significantly alleviating the uneven phenomenon of the light exit surface. Additionally, the present invention provides a one-time molding process without adding particles to simplify the production process and reduce production costs.

To achieve the objective of the present invention, the following technologies are used.

According to an aspect, a diffusion film is provided, where a light exit surface and/or a light entrance surface of the diffusion film has a continuous or discontinuous optical micro-structure, the optical micro-structure presenting a laminated structure.

Further, the optical micro-structure includes at least one platform;
the platform has planes that are horizontally parallel to each other;
the platform has at least one continuous light exit circumferential-side surface; and
contours of the platforms sequentially enlarge/shrink along a direction perpendicular to the light exit surface of the diffusion film and form a stepped structure, and a projection of the platform at an upper level is located within the contour of the platform at a lower level.

Further, the light exit circumferential-side surface of the platform is a plane, and the platform has at least three light exit circumferential-side surfaces.

Further, the light exit circumferential-side surface of the platform is a continuous arc surface, and the platform has one light exit circumferential-side surface.

Further, there is at least one top platform on a top of the platforms;
a circumferential side of the top platform is a conical surface, and an axial direction of the top platform is perpendicular to the light exit surface of the diffusion film; and/or
the top platform is of a conical structure, and a height direction of the top platform is perpendicular to the light exit surface of the diffusion film.

Further, a bottom of the top platform and the platform located at the top form an included angle of 1-89 degrees.

Further, the optical micro-structure protrudes out of the light exit surface of the diffusion film and/or the optical micro-structure is concaved in the light exit surface of the diffusion film.

Further, a height of the optical micro-structure is equal to or greater than 1 μm; and
a width or diameter of the optical micro-structure is equal to or greater than 1 μm.

According to another aspect, a diffusion film preparation method is provided, which is used for preparing the diffusion film using a film pressing apparatus, and includes the following steps:
providing a lower substrate plate, where the lower substrate plate is provided with multiple concave molds that present a laminated structure, the lower substrate plate is provided with multiple air holes, and a lower end of the air hole is connected to an air pump via a pipe; and
providing a lower pressing plate that reciprocates up and down, where a lower wall of the lower pressing plate is provided with multiple convex molds that present a laminated structure, the convex molds and the concave molds have a same number, and the convex molds are in one-to-one correspondence to the concave molds.

During preparation of the diffusion film, the convex molds that present the laminated structure on the lower pressing plate act on the diffusion film to form the optical micro-structure that presents a laminated structure on the diffusion film.

Further, the film pressing apparatus includes a conveying mechanism, a film pressing mechanism, and a transmission mechanism.

The conveying mechanism includes a pair of side plates, the side plate is mounted with a rotating seat, a lower support roller is rotatably disposed between lower ends of the side plates, an upper end of the side plate is mounted with a rotating ring, the rotating ring is mounted on the side plate via multiple mounting plates, a rotating disk is rotatably provided in the rotating ring, four convex plates are provided as a circumferential array at an inner side end of each rotating disk, four conveying arc plates are provided between the rotating disks, two ends of the conveying arc plate are both mounted on the convex plates, and an outer wall of the conveying arc plate forms an arc structure. An outer side end of the rotating disk is provided with a groove that presents a cruciform structure, an intersection of the groove is provided with a circular groove, four convex blocks are provided as a circumferential array at the outer side end of the rotating disk, an inner wall of the convex block is concaved to form a concave arc groove, and the convex blocks are all located on diagonals of the groove. An end of the rotating seat is rotatably provided with a first rotating shaft, an inner side end of the first rotating shaft is provided with a first gear, the first gear meshes with a second gear, the second gear is connected to a second rotating shaft, an outer side end of the second rotating shaft is disposed on the rotating seat, an inner side end of the second rotating shaft is provided with a rotating plate, an end of the rotating plate is provided with a fan-shaped plate, an outer wall of the fan-shaped plate is of an arc structure, an inner side end of the rotating plate is provided with a toggle rod, when in the groove, the toggle rod is configured to toggle the rotating disk to rotate, and when the fan-shaped plate is located in the concave arc groove, the rotating disk stops rotating.

The film pressing mechanism includes a pair of fixed end plates, the lower substrate plate is mounted between lower ends of the fixed end plates, the lower substrate plate is provided with the multiple concave molds that present a laminated structure, the lower substrate plate is provided with the multiple air holes, and the lower end of the air hole is connected to the air pump via the pipe, an upper end of each fixed end plate is mounted with a pair of mounting members each presenting a cruciform structure, the mounting member is mounted with an inner gear ring, a third gear meshes within the inner gear ring, the third gear is coaxially provided with a third rotating shaft, an inner side end of the third rotating shaft is provided with a rotary plate, another end of the rotary plate is rotatably provided with a connecting convex plate, a lower end of the connecting convex plate is mounted with the lower pressing plate, the lower wall of the lower pressing plate is provided with the multiple convex molds that present a laminated structure, the convex molds and the concave molds have the same number, the convex molds are in one-to-one correspondence to the concave molds, an outer side end of the third rotating shaft is provided with an external connection plate, another end of the external connection plate is provided with a fourth rotating shaft, the fourth rotating shaft and the inner gear ring are co-axial, the fourth rotating shaft is rotatably disposed on the mounting member, an outer side end of the fourth rotating shaft is provided with a fifth gear, a sixth gear meshes between each pair of fifth gears at a same end, the sixth gear is rotatably disposed on the fixed end plate via a driving shaft, the lower pressing plate extends upwards to be provided with multiple upper guide rods, an upper plate sleeves the upper guide rods, and two ends of the upper plate are mounted at the upper ends of the fixed end plates. The transmission mechanism includes a motor mounting plate mounted at an upper end of the fixed end plate, a motor is mounted on the motor mounting plate, an output shaft of the motor is connected to the driving shaft, the driving shaft is provided with a driving wheel, an outer side end of the first rotating shaft is provided with a driven wheel, and a synchronous belt enables transmission between the driving wheel and the driven wheel.

The above technical solutions have the following advantages:
(1) The present invention introduces at least one layer of square or circular platform in the laminated optical micro-structure. Increasing the light exit amount in the horizontal direction increases the light exit area of a single LED lamp, thereby enhancing the light mixing effect between LED lamps, weakening the dark light band between LED lamps, and ultimately improving the uniform light effect of the diffusion film.
(2) In the present invention, the optical micro-structure that presents a laminated structure is prepared on the diffusion film, uniformly reflecting and refracting the light emitted by the light source, thus resolving the problems in the prior art. In addition, in the present invention, the use of the method or apparatus that facilitates preparation of the diffusion film avoids deformation during demolding and is conducive to conveying the diffusion film during preparation.

### BRIEF DESCRIPTION OF THE DRAWINGS

To make the objectives, technical solutions, and advantages of the present invention clearer, the following will provide a more detailed description of the present invention with reference to the accompanying drawings.

FIG. 1 is a perspective structural view of an optical micro-structure in Embodiment 2.

FIG. 2 is a structural diagram of optical micro-structures in Embodiment 3, where FIG. (A) is a perspective structural view of an optical micro-structure without a top platform structure, FIG. (B) is a perspective structural view of an optical micro-structure with a top platform structure, FIG. (C) is a simple light path diagram of the optical micro-structure without a top platform structure, and FIG. (D) is a simple light path diagram of the optical micro-structure with a top platform structure.

FIG. 3 is a structural diagram of optical micro-structures in Embodiment 4, where FIG. (A) is a perspective structural view of an optical micro-structure with a top platform structure, FIG. (B) is a perspective structural view of an optical micro-structure without a top platform structure, FIG. (C) is a simple light path diagram of the optical micro-structure with a top platform structure, and FIG. (D) is a simple light path diagram of the optical micro-structure without a top platform structure.

FIG. 4 is a structural diagram of an optical micro-structure in Embodiment 5, where FIG. (A) is a perspective structural view of an optical micro-structure, and FIG. (B) is a simple light path diagram of the optical micro-structure.

FIG. 5 is a structural diagram of sizes of the optical micro-structures in Embodiments 3 and 4.

FIG. 6 is a structural diagram of sizes of top platforms of the optical micro-structures and platforms at the top in Embodiments 3, 4, and 5.

FIG. 7 is a diagram of comparison between implementation effects of different optical micro-structures.

FIG. 8 is a schematic diagram of an optical micro-structure protruding out of a light exit surface of a diffusion film or being recessed in the light exit surface of the diffusion film.

FIG. 9 is a perspective structural view of a film pressing apparatus.

FIG. 10 is a perspective structural view of a conveying mechanism.

FIG. 11 is a perspective structural view of a first part of the conveying mechanism.

FIG. 12 is a perspective structural view of a second part of the conveying mechanism.

FIG. 13 is a perspective structural view of a third part of the conveying mechanism.

FIG. 14 is a perspective structural view of a film pressing mechanism.

FIG. 15 is a perspective structural view of a first part of the film pressing mechanism.

### DETAILED DESCRIPTION OF PREFERRED EMBODIMENTS

### Embodiment 1

A diffusion film is provided, where a light exit surface of the diffusion film has no optical micro-structure. This embodiment serves as a comparative embodiment for comparing and referencing effects of other embodiments.

### Embodiment 2

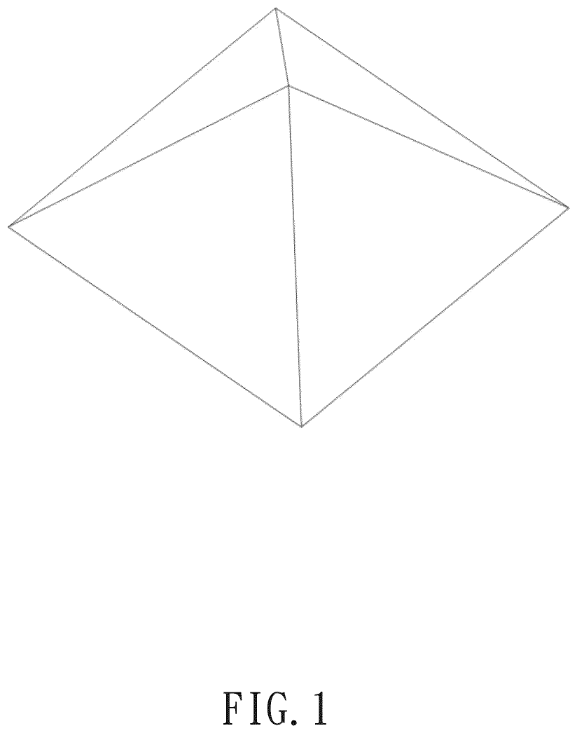

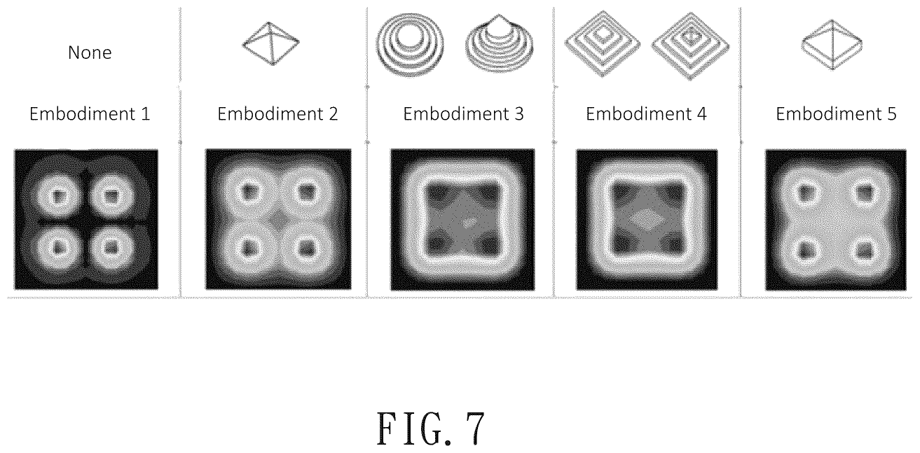

As shown in FIG. 1, a diffusion film is provided. A light exit surface and/or a non-light exit surface of the diffusion film has a continuous or discontinuous optical micro-structure, the optical micro-structure presenting a pyramid-shaped structure. As shown in FIG. 7, when such an optical micro-structure is arranged on the light exit surface and/or the light entrance surface of the diffusion film, a certain light mixing effect can be achieved by reflecting and refracting the light from the light source, but the boundaries between bright and dark regions are clear. This thus does not achieve a good uniform light effect by light mixing.

### Embodiment 3

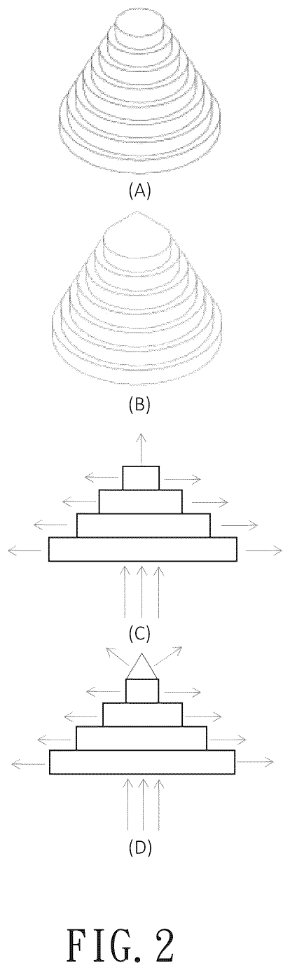

As shown in FIG. 2, a diffusion film is provided. A light exit surface and/or a light entrance surface of the diffusion film has a continuous or discontinuous optical micro-structure, the optical micro-structure presenting a laminated structure.

As shown in FIG (A) in FIG. 2, specifically, the optical micro-structure includes multiple platforms. The platform has planes that are horizontally parallel to each other, the platform has one continuous light exit circumferential-side surface, and the light exit circumferential-side surface of the platform is a continuous arc surface. Contours of the platforms sequentially enlarge/shrink along a direction perpendicular to the light exit surface of the diffusion film and form a stepped structure, and a projection of the platform at an upper level is located within the contour of the platform at a lower level.

As shown in FIG. (B) in FIG. 2, specifically, there is one top platform on a top of the platforms, a circumferential side of the top platform is a conical surface, and an axial direction of the top platform is perpendicular to the light exit surface of the diffusion film.

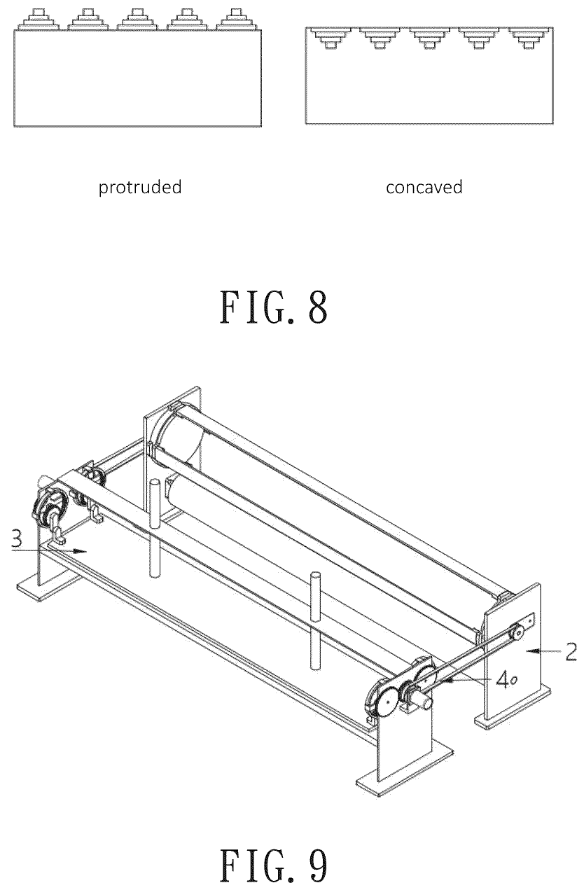

Specifically, as shown in FIG. 8, the optical micro-structure protrudes out of the light exit surface of the diffusion film and/or the optical micro-structure is concaved in the light exit surface of the diffusion film.

From the diagrams (C) and (D) in FIG. 2 and the specific effect diagram in FIG. 7, it can be known that as compared with Embodiment 1, the diffusion film and the stepped pyramid structure provided in this embodiment use the circumferential side surface of the platform to converge the light source to the horizontal direction, increasing the chances of reflection and refraction in the horizontal direction of the light source. The stepped pyramid structure, compared with the ordinary pyramid structure, significantly improves the uniform light effect by light mixing.

### Embodiment 4

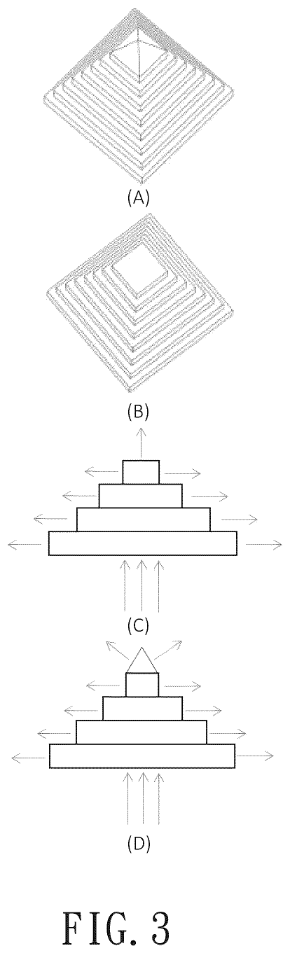

As shown in FIG. 3, a diffusion film is provided. A light exit surface and/or a light entrance surface of the diffusion film has a continuous or discontinuous optical micro-structure, the optical micro-structure presenting a laminated structure.

As shown in FIG (B) in FIG. 3, specifically, the optical micro-structure includes multiple platforms. The platform has planes that are horizontally parallel to each other, the platform has four continuous light exit circumferential-side surfaces, and the light exit circumferential-side surface of the platform is a continuous arc surface or a plane. Contours of the platforms sequentially enlarge/shrink along a direction perpendicular to the light exit surface of the diffusion film and form a stepped structure, and a projection of the platform at an upper level is located within the contour of the platform at a lower level. As shown in diagram (C) in FIG. 3, an optical micro-structure being of a square stepped structure is used. When light passes through the optical micro-structure, multiple stepped structures thereon cause some light to be refracted and reflected and eventually emitted horizontally from a side surface of the optical micro-structure, thus directing the light path or light. As the number of stacked layers increases, more parallel light appears, and the increase in the horizontal light improves the light mixing effect between LED lamps.

Specifically, there is one top platform on a top of the platforms, the top platform is of a conical structure, and a height direction of the top platform is perpendicular to the light exit surface of the diffusion film. Specifically referring to diagrams (A) and (D) in FIG. 3, a square conical structure is arranged on the top of the platforms, and horizontal light is emitted from the square structure when the LED operates, significantly improving the light mixing effect.

Specifically, as shown in FIG. 8, the optical micro-structure protrudes out of the light exit surface of the diffusion film and/or the optical micro-structure is concaved in the light exit surface of the diffusion film.

To facilitate a visual description of this embodiment and Embodiment 3, the structures involved in this embodiment and Embodiment 3 are specifically described as follows.

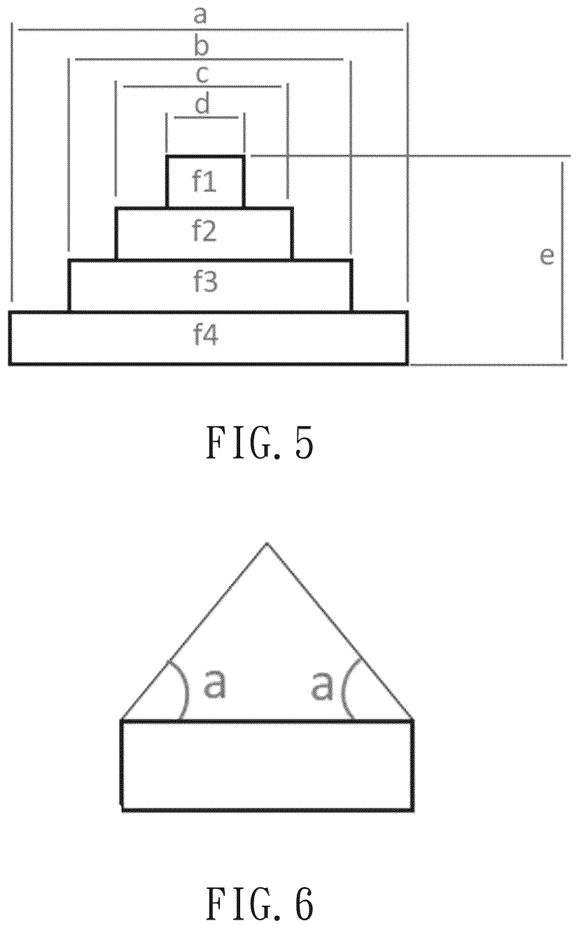

As shown in FIG. 5, it can be known that the platforms in the optical micro-structure are named f1, f2, f3, f4, . . . , and fn. In this figure, only f1, f2, f3, and f4 are shown, where the diameter or width of f4 is a, and a>1 μm. The diameter or width of f3 is b, and a relationship between the diameter or width b of f3 and the diameter or width a of f4 satisfies a>b. The diameter or width of f2 is c, and a relationship between the diameter or width c of f2 and the diameter or width b of f3 satisfies b>c. The diameter or width of f1 is d, and a relationship between the diameter or width c of f2 and the diameter or width d of f1 satisfies c≥d. The height e of the circular stepped structure or square stepped structure is equal to or greater than 1 μm.

As shown in FIG. 6, the structural diagram of a top platform and a platform located at the top is shown, where the bottom of the top platform and the platform located at the top form an included angle a of 1-89 degrees.

### Embodiment 5

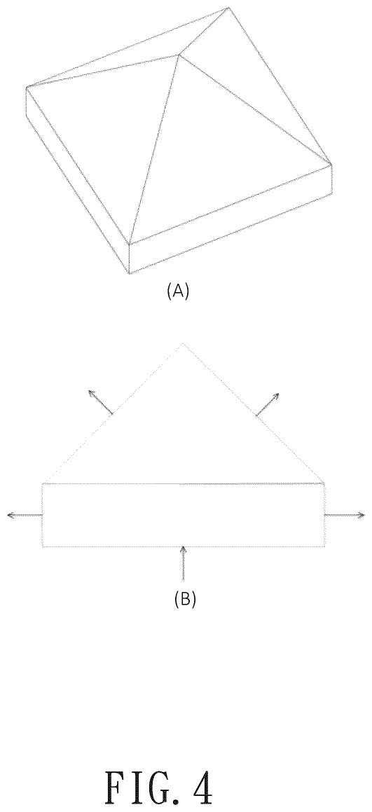

A diffusion film is provided, its structure being shown in FIG. (A) in FIG. 4. A light exit surface and/or a light entrance surface of the diffusion film has a continuous or discontinuous optical micro-structure, the optical micro-structure presenting a laminated structure.

Specifically, the optical micro-structure includes one platform. The platform has planes that are horizontally parallel to each other, the platform has four continuous light exit circumferential-side surfaces, and the light exit circumferential-side surface of the platform is a plane. Contours of the platforms sequentially enlarge/shrink along a direction perpendicular to the light exit surface of the diffusion film and form a stepped structure, and a projection of the platform at an upper level is located within the contour of the platform at a lower level.

Specifically, there is at least one top platform on a top of the platforms, the top platform is of a conical structure, and a height direction of the top platform is perpendicular to the light exit surface of the diffusion film.

Specifically, a bottom of the top platform and the platform located at the top form an included angle of 1-89 degrees.

Specifically, as shown in FIG. 8, the optical micro-structure protrudes out of the light exit surface of the diffusion film and/or the optical micro-structure is concaved in the light exit surface of the diffusion film.

With reference to FIG. 7 and FIG. (B) of FIG. 4, it can be known that as compared with Embodiment 1, the stepped pyramid structure in the diffusion film uses the circumferential side surface of the platform to converge the light source to the horizontal direction, increasing the chances of reflection and refraction in the horizontal direction of the light source. The stepped pyramid structure, compared with the ordinary pyramid structure, significantly improves the uniform light effect by light mixing

In addition, the platforms involved in the optical micro-structure of the present invention may also be of other polygons, such as triangles, pentagons, and other polygonal structures, which are not shown in the drawings. It should be noted that this should be regarded as a simple modification of the present utility model, regardless of the number of the light exit circumferential-side surfaces of the platform, as long as the horizontal propagation of light can be achieved to increase the light mixing effect. As a further optimization, a top platform structure of the corresponding shape may further be on the top of the polygonal platform.

Through the display diagrams of the light mixing effects among different embodiments in FIG. 7, it can be seen that Embodiments 3 to 5 exhibit better light mixing effects, significantly weakening the dark light band between LED lamps and achieving notable uniform light effects.

### Embodiment 6

As shown in FIG. 9, a film pressing apparatus is provided for preparing the diffusion film of Embodiments 2-5, including a conveying mechanism 2, a film pressing mechanism 3, and a transmission mechanism 4.

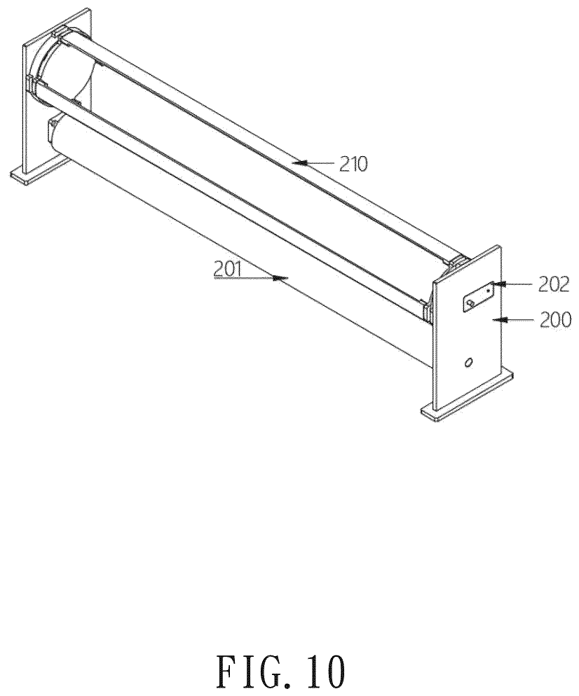

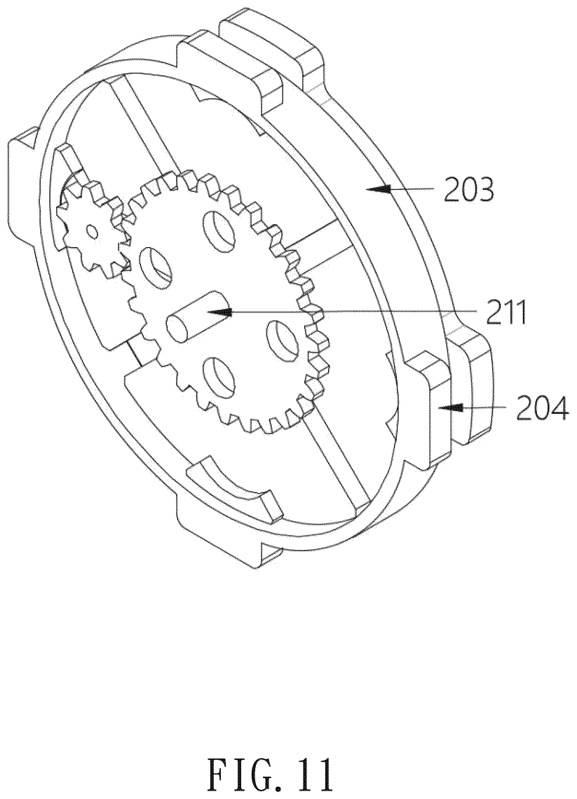

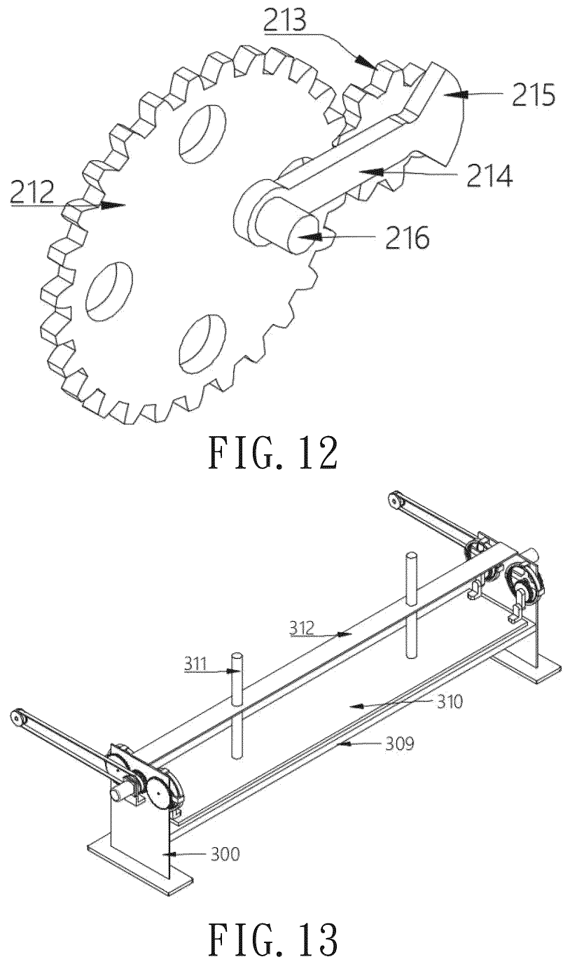

As shown in FIGS. 10 to 13, the conveying mechanism 2 includes a pair of side plates 200, the side plate 200 is mounted with a rotating seat 202, a lower support roller 201 is rotatably disposed between lower ends of the side plates 200, an upper end of the side plate 200 is mounted with a rotating ring 203, the rotating ring 203 is mounted on the side plate 200 via multiple mounting plates 204, a rotating disk 205 is rotatably provided in the rotating ring 203, four convex plates 206 are provided as a circumferential array at an inner side end of each rotating disk 205, four conveying arc plates 210 are provided between the rotating disks 205, two ends of the conveying arc plate 210 are both mounted on the convex plates 206, and an outer wall of the conveying arc plate 210 forms an arc structure. An outer side end of the rotating disk 205 is provided with a groove 207 that presents a cruciform structure, an intersection of the groove 207 is provided with a circular groove 220, four convex blocks 208 are provided as a circumferential array at the outer side end of the rotating disk 205, an inner wall of the convex block 208 is concaved to form a concave arc groove, and the convex blocks 208 are all located on diagonals of the groove 207. An end of the rotating seat 202 is rotatably provided with a first rotating shaft 211, an inner side end of the first rotating shaft 211 is provided with a first gear 212, the first gear 212 meshes with a second gear 213, the second gear 213 is connected to a second rotating shaft, an outer side end of the second rotating shaft is disposed on the rotating seat 202, an inner side end of the second rotating shaft is provided with a rotating plate 214, an end of the rotating plate 214 is provided with a fan-shaped plate 215, an outer wall of the fan-shaped plate 215 is of an arc structure, an inner side end of the rotating plate 214 is provided with a toggle rod 216, when in the groove 207, the toggle rod 216 is configured to toggle the rotating disk 205 to rotate, and when the fan-shaped plate 215 is located in the concave arc groove, the rotating disk 205 stops rotating.

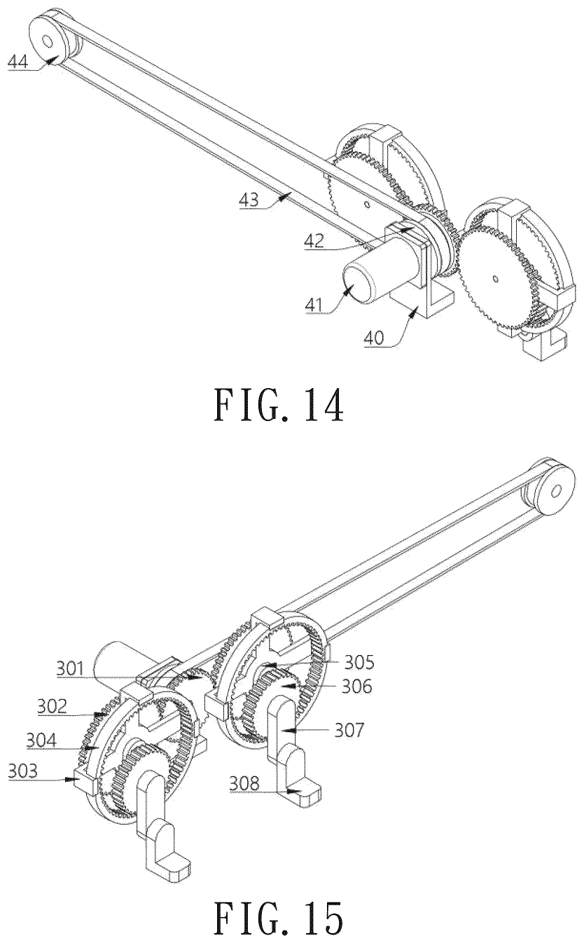

As shown in FIGS. 14 and 15, the film pressing mechanism 3 includes a pair of fixed end plates 300, the lower substrate plate 309 is mounted between lower ends of the fixed end plates 300, the lower substrate plate 309 is provided with the multiple concave molds that present a laminated structure, the lower substrate plate 309 is provided with the multiple air holes, and the lower end of the air hole is connected to the air pump via the pipe. An upper end of each fixed end plate 300 is mounted with a pair of mounting members 303 each presenting a cruciform structure, the mounting member 303 is mounted with an inner gear ring 304, a third gear 306 meshes within the inner gear ring 304, the third gear 306 is coaxially provided with a third rotating shaft, an inner side end of the third rotating shaft is provided with a rotary plate 307, another end of the rotary plate 307 is rotatably provided with a connecting convex plate 308, a lower end of the connecting convex plate 308 is mounted with the lower pressing plate 310, the lower wall of the lower pressing plate 310 is provided with the multiple convex molds that present a laminated structure, the convex molds and the concave molds have the same number, and the convex molds are in one-to-one correspondence to the concave molds. An outer side end of the third rotating shaft is provided with an external connection plate 305, another end of the external connection plate 305 is provided with a fourth rotating shaft, the fourth rotating shaft and the inner gear ring 304 are co-axial, the fourth rotating shaft is rotatably disposed on the mounting member 303, an outer side end of the fourth rotating shaft is provided with a fifth gear 302, a sixth gear 301 meshes between each pair of fifth gears 302 at a same end, the sixth gear 301 is rotatably disposed on the fixed end plate 300 via a driving shaft, the lower pressing plate 310 extends upwards to be provided with multiple upper guide rods 311, an upper plate 312 sleeves the upper guide rods 311, and two ends of the upper plate 312 are mounted at the upper ends of the fixed end plates 300. The transmission mechanism 4 includes a motor mounting plate 40 mounted at an upper end of the fixed end plate 300, a motor 41 is mounted on the motor mounting plate 40, an output shaft of the motor 41 is connected to the driving shaft, the driving shaft is provided with a driving wheel 42, an outer side end of the first rotating shaft 211 is provided with a driven wheel 44, and a synchronous belt 43 enables transmission between the driving wheel 42 and the driven wheel 44.

During operation, the pre-prepared diffusion film is preheated, and then the diffusion film passes through the film pressing mechanism 3. When the diffusion film passes through the film pressing mechanism 3, the lower pressing plate 310 and the lower substrate plate 309 at the terminal end of the film pressing mechanism 3 press the diffusion film therebetween into shape. During the pressing and shaping process, air needs to be pumped out through an air pump, causing the diffusion film to be closely attached to the lower substrate plate 309. After the pressing and shaping are completed, the lower pressing plate 310 moves upward, and the air pump ventilates the air holes of the lower substrate plate 309, causing the diffusion film attached to the lower substrate plate 309 to move upward, with the pressed optical micro-structure smoothly pulled out of the concave mold. Then, the diffusion film is cooled and shaped by an air cooling or water cooling apparatus, and the diffusion film is driven by the conveying mechanism 1 to be continuously conveyed forward.

When the diffusion film is conveyed, the diffusion film is positioned above the lower support roller 201. During conveying, the motor 41 drives the first rotating shaft 211 to rotate via the driving wheel 42, the synchronous belt 43, and the driven wheel 44. The rotation of the first rotating shaft 211 drives the first gear 212 to rotate, the rotation of the first gear 212 drives the second gear 213 to rotate, and the rotation of the second gear 213 drives the rotating plate 214 to rotate. During the rotation of the rotating plate 214, the toggle rod 216 rotates around the axial direction of the second gear 213. As the toggle rod 216 rotates, it acts on the side wall of the groove 207 presenting a cruciform structure, causing the rotating disk 205 to rotate around its axial direction. When the toggle rod 216 loses its acting force on the side wall of the groove 207, the fan-shaped plate 215 is in the concave arc groove, and the rotating disk 205 stops rotating. When the toggle rod 216 acts on the side wall of the groove 207 and causes the rotating disk 205 to rotate, the conveying arc plate 210 mounted on the rotating disk 205 interacts with the lower support roller 201. The rotation of the conveying arc plate 210 drives the diffusion film to be conveyed forward. This method allows the rotating disk 205 to rotate periodically, thereby achieving periodic pushing of the diffusion film. This provides sufficient time for the pressing and shaping of the optical micro-structure on the diffusion film and facilitates the subsequent winding operation of the diffusion film. The rotating ring 203 provided ensures the stable rotation of the rotating disk 205.

When the optical micro-structure of the diffusion film is shaped, the motor 41 drives the driving shaft to rotate, the rotation of the driving shaft drives the sixth gear 301 to rotate, and the rotation of the sixth gear 301 drives the two fifth gears 302 to rotate. The rotation of the fifth gear 302 drives the external connection plate 305 to rotate around one end of the fifth gear 302. The rotation of the external connection plate 305 drives the third gear 306 to rotate. When the third gear 306 rotates, it causes the rotary plate 307 to rotate. At this time, the rotary plate 307 also moves around the inner gear ring 304. This movement manner causes the lower pressing plate 310 to reciprocate up and down. When the lower pressing plate 310 moves downward, it interacts with the lower substrate plate 309 and completes the pressing and shaping of the diffusion film. The upper guide rods 311 guide and limit the movement of the lower pressing plate 310, thereby ensuring stability and accuracy during shaping.

### Embodiment 7

A diffusion film preparation method is provided, which is used for preparing the diffusion films of Embodiments 2-5 using the film pressing apparatus provided in Embodiment 6, and includes the following steps:
providing a lower substrate plate 309, where the lower substrate plate 309 is provided with multiple concave molds that present a laminated structure, the lower substrate plate 309 is provided with multiple air holes, and a lower end of the air hole is connected to an air pump via a pipe; and
providing a lower pressing plate 310 that reciprocates up and down, where a lower wall of the lower pressing plate 310 is provided with multiple convex molds that present a laminated structure, the convex molds and the concave molds have a same number, and the convex molds are in one-to-one correspondence to the concave molds; where
during preparation of the diffusion film, the convex molds that present the laminated structure on the lower pressing plate 310 act on the diffusion film to form the optical micro-structure that presents a laminated structure on the diffusion film.

The above descriptions are merely preferred embodiments of the present invention and are not intended to limit the present invention. It is apparent that those skilled in the art can make various modifications and variations to the present invention without departing from the spirit and scope of the present invention. Thus, if these modifications and variations of the present invention fall within the scope of the claims and their equivalent techniques of the present invention, the present invention also intends to include these modifications and variations.

What is claimed is:

1. A diffusion film, wherein a light exit surface and/or a light entrance surface of the diffusion film has a continuous or discontinuous optical micro-structure, and the optical micro-structure presents a laminated structure.

2. The diffusion film according to claim 1, wherein the optical micro-structure comprises at least one platform;
the platform has planes that are horizontally parallel to each other;
the platform has at least one continuous light exit circumferential-side surface; and
contours of the platforms sequentially enlarge/shrink along a direction perpendicular to the light exit surface of the diffusion film and form a stepped structure, and a projection of the platform at an upper level is located within the contour of the platform at a lower level.

3. The diffusion film according to claim 2, wherein the light exit circumferential-side surface of the platform is a plane, and the platform has at least three light exit circumferential-side surfaces.

4. The diffusion film according to claim 2, wherein the light exit circumferential-side surface of the platform is a continuous arc surface, and the platform has one light exit circumferential-side surface.

5. The diffusion film according to claim 2, wherein
there is at least one top platform on a top of the platforms;
a circumferential side of the top platform is a conical surface, and an axial direction of the top platform is perpendicular to the light exit surface of the diffusion film; and/or
the top platform is of a conical structure, and a height direction of the top platform is perpendicular to the light exit surface of the diffusion film.

6. The diffusion film according to claim 5, wherein a bottom of the top platform and the platform located at the top form an included angle of 1-89 degrees.

7. The diffusion film according to claim 1 or 2, wherein the optical micro-structure protrudes out of the light exit surface of the diffusion film and/or the optical micro-structure is concaved in the light exit surface of the diffusion film.

8. The diffusion film according to claim 1 or 2, wherein
a height of the optical micro-structure is equal to or greater than 1 μm; and
a width or diameter of the optical micro-structure is equal to or greater than 1 μm.

9. A diffusion film preparation method, used for preparing the diffusion film according to claim 1 using a film pressing apparatus, and comprising the following steps:
providing a lower substrate plate (309), wherein the lower substrate plate (309) is provided with multiple concave molds that present a laminated structure, the lower substrate plate (309) is provided with multiple air holes, and a lower end of the air hole is connected to an air pump via a pipe; and
providing a lower pressing plate (310) that reciprocates up and down, wherein a lower wall of the lower pressing plate (310) is provided with multiple convex molds that present a laminated structure, the convex molds and the concave molds have a same number, and the convex molds are in one-to-one correspondence to the concave molds; wherein
during preparation of the diffusion film, the convex molds that present the laminated structure on the lower pressing plate (310) act on the diffusion film to form the optical micro-structure that presents a laminated structure on the diffusion film.

10. The diffusion film preparation method according to claim 9, wherein the film pressing apparatus comprises a conveying mechanism (2), a film pressing mechanism (3), and a transmission mechanism (4); wherein
the conveying mechanism (2) comprises a pair of side plates (200), the side plate (200) is mounted with a rotating seat (202), a lower support roller (201) is rotatably disposed between lower ends of the side plates (200), an upper end of the side plate (200) is mounted with a rotating ring (203), the rotating ring (203) is mounted on the side plate (200) via multiple mounting plates (204), a rotating disk (205) is rotatably provided in the rotating ring (203), four convex plates (206) are provided as a circumferential array at an inner side end of each rotating disk (205), four conveying arc plates (210) are provided between the rotating disks (205), two ends of the conveying arc plate (210) are both mounted on the convex plates (206), and an outer wall of the conveying arc plate (210) forms an arc structure;
an outer side end of the rotating disk (205) is provided with a groove (207) that presents a cruciform structure, an intersection of the groove (207) is provided with a circular groove (220), four convex blocks (208) are provided as a circumferential array at the outer side end of the rotating disk (205) an inner wall of the convex block (208) is concaved to form a concave arc groove, and the convex blocks (208) are all located on diagonals of the groove (207);
an end of the rotating seat (202) is rotatably provided with a first rotating shaft (211), an inner side end of the first rotating shaft (211) is provided with a first gear (212), the first gear (212) meshes with a second gear (213), the second gear (213) is connected to a second rotating shaft, an outer side end of the second rotating shaft is disposed on the rotating seat (202), an inner side end of the second rotating shaft is provided with a rotating plate (214), an end of the rotating plate (214) is provided with a fan-shaped plate (215), an outer wall of the fan-shaped plate (215) is of an arc structure, an inner side end of the rotating plate (214) is provided with a toggle rod (216), when in the groove (207), the toggle rod (216) is configured to toggle the rotating disk (205) to rotate, and when the fan-shaped plate (215) is located in the concave arc groove, the rotating disk (205) stops rotating;
the film pressing mechanism (3) comprises a pair of fixed end plates (300), the lower substrate plate (309) is mounted between lower ends of the fixed end plates (300), the lower substrate plate (309) is provided with the multiple concave molds that present a laminated structure, the lower substrate plate (309) is provided with the multiple air holes, the lower end of the air hole is connected to the air pump via the pipe, an upper end of each fixed end plate (300) is mounted with a pair of mounting members (303) each presenting a cruciform structure, the mounting member (303) is mounted with an inner gear ring (304), a third gear (306) meshes within the inner gear ring (304), the third gear (306) is coaxially provided with a third rotating shaft, an inner side end of the third rotating shaft is provided with a rotary plate (307), another end of the rotary plate (307) is rotatably provided with a connecting convex plate (308), a lower end of the connecting convex plate (308) is mounted with the lower pressing plate (310), the lower wall of the lower pressing plate (310) is provided with the multiple convex molds that present a laminated structure, the convex molds and the concave molds have the same number, the convex molds are in one-to-one correspondence to the concave molds, an outer side end of the third rotating shaft is provided with an external connection plate (305), another end of the external connection plate (305) is provided with a fourth rotating shaft, the fourth rotating shaft and the inner gear ring (304) are co-axial, the fourth rotating shaft is rotatably disposed on the mounting member (303), an outer side end of the fourth rotating shaft is provided with a fifth gear (302), a sixth gear

(301) meshes between each pair of fifth gears (302) at a same end, the sixth gear (301) is rotatably disposed on the fixed end plate (300) via a driving shaft, the lower pressing plate (310) extends upwards to be provided with multiple upper guide rods (311), an upper plate (312) sleeves the upper guide rods (311), and two ends of the upper plate (312) are mounted at the upper ends of the fixed end plates (300); and
the transmission mechanism (4) comprises a motor mounting plate (40) mounted at an upper end of the fixed end plate (300), a motor (41) is mounted on the motor mounting plate (40), an output shaft of the motor (41) is connected to the driving shaft, the driving shaft is provided with a driving wheel (42), an outer side end of the first rotating shaft (211) is provided with a driven wheel (44), and a synchronous belt (43) enables transmission between the driving wheel (42) and the driven wheel
